(19) United States
(12) Patent Application Publication
(10) Pub. No.: US 2022/0169106 A1
(43) Pub. Date: Jun. 2, 2022

(54) Hybrid Transmission Unit and Motor Vehicle

(71) Applicant: ZF Friedrichshafen AG, Friedrichshafen (DE)

(72) Inventors: Stefan Beck, Eriskirch (DE); Fabian Kutter, Kressbronn (DE); Matthias Horn, Tettnang (DE); Thomas Martin, Weissensberg (DE); Michael Wechs, Weißensberg (DE); Johannes Kaltenbach, Friedrichshafen (DE); Martin Brehmer, Tettnang (DE); Peter Ziemer, Tettnang (DE); Thomas Kroh, Lindau (DE); Oliver Bayer, Hörbranz (AT); Max Bachmann, Friedrichshafen (DE)

(21) Appl. No.: 17/436,321

(22) PCT Filed: Oct. 15, 2019
(86) PCT No.: PCT/EP2019/077966

§ 371 Date: Sep. 3, 2021

(30) Foreign Application Priority Data
Mar. 5, 2019 (DE) 10 2019 202 955.8

(51) Int. Cl. B60K 6/387; B60K 6/442; B60K 6/48; B60K 6/547; F16H 3/00

(52) U.S. Cl. CPC B60K 6/387; B60K 6/442; B60K 6/48; B60K 2006/541; F16H 3/006; B60K 2006/4825; B60K 2006/4808; B60K 6/547

(57) ABSTRACT

The invention relates to a hybrid transmission device (3) with two electric motors (EM1, EM2), a first transmission input shaft (7) and a second transmission input shaft (9) mounted on the first transmission input shaft (7), wherein at least one gearwheel (10, 12, 14, 16, 18) for forming a forward gear (V1, V2, V3, V4, V5, E1, E2, E3, E4, E5) is arranged on each of the transmission input shafts (7, 9), characterized in that the first electric motor (EMI) is connected to a gearwheel (18) on the first transmission input shaft (7) and the second electric motor (EM2) is connected to a gearwheel (10) on the second transmission input shaft.

The invention also relates to a motor vehicle.

### CROSS-REFERENCE TO RELATED APPLICATIONS

The present application is related and has right of priority to German Patent Application No. 102019202955.8 filed in the German Patent Office on Mar. 5, 2019 and is a nationalization of PCT/EP2019/077966 filed in the European Patent Office on Oct. 15, 2019, both of which are incorporated by reference in their entirety for all purposes.

### FIELD OF THE INVENTION

The invention relates generally to a hybrid transmission device with two drive devices, and a transmission including a first transmission input shaft and a second transmission input shaft mounted on the first transmission input shaft. At least one gearwheel for forming a forward gear is arranged on each of the transmission input shafts.

### BACKGROUND

It is known to utilize hybrid transmission devices to reduce the carbon dioxide (CO2) emissions of motor vehicles. A hybrid transmission device is understood to be a transmission device, onto which an internal combustion engine and at least one further drive device are couplable. It is known to hybridize all automated transmissions, for example, automatic transmissions and dual clutch transmissions. DE10 2011 005 451 A1 describes a transmission, which includes two electric motors and has five forward gears and one reverse gear.

### SUMMARY OF THE INVENTION

Example aspects of the present invention provide a hybrid transmission device, which has a compact design for front-transverse applications and offers even greater functionality.

Example aspects of the present invention provide that, in a hybrid transmission device of the type mentioned at the outset, the first drive device is attached at a gearwheel on the first transmission input shaft and the second drive device is attached at a gearwheel on the second transmission input shaft. Due to this attachment, a better packing density and also an improved functionality of the hybrid transmission device can be achieved. In particular, as a result, the application point for the electric motors is displaced radially outward starting from the axis of the transmission input shafts.

The gearwheels are advantageously designed as spur gears. Therefore, the drive devices can be attached via spur gear drives.

The transmission of the hybrid transmission device is advantageously designed as a gear change transmission. The gear change transmission has at least two discrete gear steps in this case.

Advantageously, the gear change transmission can include at least two, in particular precisely two, sub-transmissions. This allows for increased functionality and, for example, tractive force support during a gear change, in particular an internal-combustion-engine gear change as well as an electric gear change.

Preferably, at least one of the sub-transmissions can be designed as a gear change transmission. In particular, two or more, in particular precisely two, sub-transmissions can be designed as gear change transmissions. In this case, one sub-transmission has at least two gear steps, and the further sub-transmission has at least one gear step.

Advantageously, one sub-transmission can have precisely three gear steps, in particular forward gear steps. In addition, a second sub-transmission can have precisely two gear steps, in particular forward gear steps.

Advantageously, the gear change transmission includes gearwheels and shift elements. The gearwheels are preferably designed as spur gears.

Preferably, the transmission of the hybrid transmission device is designed as a stationary transmission. In stationary transmissions, the axles of all gearwheels in the transmission are fixed in relation to the transmission housing.

Preferably, the gear change transmission is designed as a transmission of a countershaft design. Preferably, the gear change transmission is designed as a spur gear drive. The gearwheels are designed as spur gears in this case.

In addition, the transmission can be designed as a dual clutch transmission. It has two transmission input shafts in this case.

Preferably, the transmission can include at least two shafts. These are necessary for forming the gear steps when the transmission is designed as a stationary transmission.

In addition, the transmission preferably includes at least one, in particular at least two, transmission input shafts. Preferably, the transmission includes precisely two transmission input shafts. With three or more transmission input shafts, although a larger number of sub-transmissions can be produced, it has been proven that the described functionality can be achieved already with two transmission input shafts.

Preferably, the first transmission input shaft is designed as a solid shaft. Regardless of the design of the first transmission input shaft, the second transmission input shaft is preferably mounted on the first transmission input shaft, i.e., the second transmission input shaft is arranged coaxially thereto and encloses the first transmission input shaft. The second transmission input shaft is a hollow shaft in this case. In this case, the clutch for connecting the first transmission input shaft with an internal combustion engine and, advantageously, the clutch for connecting the second transmission input shaft with an internal combustion engine are also directly followed in the axial direction, on the engine side, by the second transmission input shaft.

Preferably, the hybrid transmission device can include at least one, in particular precisely one, countershaft. In the case that a single countershaft is utilized, a single point of attachment to the differential is present. As a result, installation space can be saved, which is the case in the radial direction as well as in the axial direction.

Therefore, the transmission in one preferred example embodiment includes precisely three shafts, namely two transmission input shafts and one countershaft, which is also the output shaft in this case.

In an all-wheel example variant of the transmission, one shaft is always added, which, as a power take-off, drives the second motor vehicle axle.

A gear step, as already described at the outset, is a mechanically implemented ratio between two shafts. The overall gear ratio between the internal combustion engine or the drive device and the wheel has further ratios, wherein the ratios upstream from a gear step, the pre-ratios, can depend on the output that is utilized. The post-ratios are usually identical. In an example embodiment shown further below, the rotational speed and the torque of a drive device are transmitted multiple times, namely by at least one gearwheel pair between the output shaft of the drive device and a transmission input shaft. This is a pre-ratio. This is followed by a gearwheel pair of a gear step with a ratio dependent on the gear step. Finally, this is followed by a gearwheel pair between the countershaft and the differential, as a post-ratio. A gear has an overall gear ratio that depends on the input and the gear step. Unless indicated otherwise, a gear relates to the utilized gear step.

Merely for the sake of clarity, it is pointed out that the ascending numbers of the gear steps refer, as usual, to a descending ratio. A first gear step G1 has a higher ratio than a second gear step G2, etc.

If torque is transmitted from the internal combustion engine via the first gear step G1, this is referred to as an internal-combustion-engine gear V1. If the second drive device and the internal combustion engine simultaneously transmit torque via the first gear step G1, this is referred to as a hybrid gear H11. If only the second drive device transmits torque via the first gear step G1, this is referred to as an electric gear E1.

In the following, gear steps refer to forward gear steps. Preferably, the transmission of the hybrid transmission device has at least three gear steps or gear stages. The gearwheels of a gear step can be arranged in a gear plane when the gear step includes two gear-step gears. In a first example embodiment, the transmission has at least four gear steps or gear stages. In a further example embodiment, the transmission preferably has at least five, in particular precisely five, gear steps or gear stages.

Preferably, the transmission of the hybrid transmission device has one gear plane more than forward gear steps. In the case of five gears, this is six gear planes. The gear plane for attaching the drive output, for example, a differential, is included in the count.

In a first example alternative, all gear steps can be utilized in an internal combustion engine-driven and electric or fluidic manner. As a result, a maximum number of gears can be obtained given a low number of gear steps. In a second example alternative, at least one, in particular precisely one, gear step is reserved solely for a drive device of the hybrid transmission device, i.e., an electric gear step. In this example embodiment, at least one other gear step can be usable for transmitting torque of the internal combustion engine as well as of a drive device. Preferably, all further gear steps are usable for transmitting torque of the internal combustion engine as well as of a drive device.

Advantageously, the hybrid transmission device and/or the transmission can be designed to be free from a reversing gearwheel for reversing the direction. Therefore, the reverse gear is not produced via the internal combustion engine, but rather via the electric motor or at least one of the electric motors. In this case, for example, the first gear step or the second gear step can be utilized.

Preferably, gear-step gearwheels for all odd gear steps, in particular forward gear steps, can be arranged on the first transmission input shaft. In addition, gear-step gears of all even gear steps, in particular forward gear steps, can preferably be arranged at the second transmission input shaft. Gear-step gears, which are also referred to as gear-step gearwheels, can be designed as fixed gears or idler gears. The gear-step gears are referred to as gear-step gears, because the gear-step gears are associated with a gear step.

Preferably, the highest even gear step and/or one of the gear-step gears associated therewith are/is located at the axial end of the transmission input shaft that supports one of the gear-step gearwheels of the highest even gear step. Preferably, the highest even gear step is the fourth gear step and/or the transmission input shaft is the second transmission input shaft. Alternatively, the transmission input shaft can be the first transmission input shaft.

Preferably, the highest odd gear step and/or one of the gear-step gears associated therewith are/is located at the axial end of the transmission input shaft that supports one of the gear-step gearwheels of the highest odd gear step. Preferably, the highest odd gear step is the fifth gear step and/or the transmission input shaft is the first transmission input shaft.

Preferably, the highest electric gear step and/or one of the gear-step gears associated therewith are/is located at the axial end of the transmission input shaft that supports one of the gear-step gearwheels of the highest electric gear step. Preferably, the highest electric gear step is a second gear step and/or the transmission input shaft is the second transmission input shaft.

In a first example embodiment, in sum, the gear-step gearwheels of the highest gear steps can be located at the axial outer sides of the shafts, in particular of the transmission input shafts. If the transmission has five forward gear steps, the fourth gear step and the fifth gear step, i.e., the gearwheels thereof, are arranged axially externally and the other gear steps and their gearwheels are arranged within these two gear steps.

Preferably, the gear-step gears of the fourth gear step and of the second gear step can be arranged on the second transmission input shaft from the outer side of the hybrid transmission device toward the inner side.

Alternatively, the gear-step gears of an electric gear step and of the first gear step can be arranged on the second transmission input shaft from the outer side of the hybrid transmission device toward the inner side.

Preferably, the gear-step gears of the fifth gear step, of the first gear step, and of the third gear step can be arranged on the first transmission input shaft from the outer side of the hybrid transmission device toward the inner side.

Alternatively, the gear-step gears of the fourth gear, of the second gear, and of the third gear can be arranged on the first transmission input shaft from the outer side of the hybrid transmission device toward the inner side.

Preferably, the hybrid transmission device can include at least two, in particular precisely two, drive devices. An arrangement of one or multiple drive device(s) that act(s) at a certain point of the hybrid transmission device counts as a drive device. This means, for example, in an example embodiment of the drive devices as electric motors, that multiple small electric motors can also be considered to be one electric motor if the multiple small electric motors summarize their torque at a single starting point.

Advantageously, at least one drive device each can be associated with the first transmission input shaft as well as with the second transmission input shaft. The gears implemented via the first transmission input shaft and the gears implemented via the second transmission input shaft form a sub-transmission in each case. It may therefore also be stated that at least one drive device is associated with each sub-transmission. Preferably, the hybrid transmission device includes at least two, in particular precisely two, sub-transmissions.

Preferably, at least one of the drive devices is designed as a generator.

Preferably, the first drive device and/or the second drive device are/is designed as a motor and as a generator.

Preferably, the drive device is attached to the highest gear step of the transmission. In the case of two drive devices, it is advantageously provided, in a first example embodiment, that they are attached to the two highest gear steps. In a further example embodiment, it is provided that the drive devices are each attached to the highest gear step of a particular sub-transmission. The two highest gear steps can also be arranged in a single sub-transmission. In addition, the drive devices can each be attached to the highest gear steps on a transmission input shaft.

Preferably, the drive device is attached to an axially externally situated gear step, more precisely, to one of the gearwheels of the gear step, of the transmission. In the case of two drive devices, it is advantageously provided that both are attached to an axially externally situated gear step of the transmission. As a result, the center distance of the attachment points can be maximized.

At this point, it is to be pointed out that, in the present invention, a connection or operative connection refers to any power flow-related connection, also across other components of the transmission. An attachment, however, refers to the first connecting point for transmitting drive torque between the prime mover and the transmission.

An attachment to a gear step, i.e., one of the gear-step gearwheels of the gear step, can take place via a gearwheel. An additional intermediate gear may be necessary, in order to bridge the center distance between the output shaft of the drive device and the transmission input shaft. Due to the attachment of the drive device to a gear-step gearwheel, a further gear plane can be avoided, which would be present only for attaching the drive device.

Advantageously, at least one of the axially external gear-step gears, which are arranged on the axis of the transmission input shafts, can be designed as a fixed gear. Preferably, both axially external gear-step gears can be designed as fixed gears. In this case, the drive devices are attached to a fixed gear on the first transmission input shaft and/or to a fixed gear on the second transmission input shaft. The drive devices can therefore preferably be arranged in a P3 arrangement, i.e., at the transmission gear set.

Preferably, a drive device can be attached to the third gear stage. Alternatively or additionally, a drive device can be attached to the single electric gear step.

Alternatively or additionally, a drive device can be attached to the fourth gear step. Alternatively or additionally, a drive device can be attached to the fifth gear step.

Preferably, the first drive device can be rotationally fixed to the internal combustion engine in all internal-combustion-engine forward gears and/or during an internal-combustion-engine gear change. In this case, a constant connection exists between the internal combustion engine and the first drive device during internal combustion engine-driven travel. Preferably, the first drive device can be utilized, at least intermittently, as a generator in all forward gears except for the crawler gear.

Preferably, the second drive device can be utilized for an electric or fluidic forward starting operation. In this case, the second drive device can be coupled, advantageously, to the gear-step gears of the second gear. The starting operation is always performed by the second drive device. The second drive device can preferably be utilized as a sole drive source for the starting operation. The second drive device can also be utilized for electric or fluidic travel in reverse. Preferably, it can also be provided here that the second drive device is the sole drive source during travel in reverse. In this case, there are no internal-combustion-engine or hybrid reverse gears.

Preferably, the drive devices can be arranged axially parallel to the first transmission input shaft. The drive devices are then preferably also axially parallel to the second transmission input shaft and to the countershaft. In the present invention, an axially parallel arrangement refers not only to completely parallel arrangements. An inclination or an angle between the longitudinal axis of the transmission input shafts and the longitudinal axis of the electric motor can also be present. Preferably, an angle is provided between the longitudinal axis of an electric motor and the longitudinal axis of the transmission input shafts of less than or equal to ten degrees (10°), further preferably less than five degrees (5°) and, in particular zero degrees (0°). Slight inclinations of the drive devices in comparison to the transmission can result for reasons related to installation space.

Preferably, the drive devices can be counter-rotatingly arranged. This means, the output shafts of the drive devices point toward different, opposite sides. If the first drive device has its output side on the left, the second drive device has the output side on the right or, if the viewing direction is changed, one drive device has its output side at the front and the other drive device has the output side at the rear. As a result, the engagement point of the drive devices at the hybrid transmission device are axially spaced apart and improved coverage in the axial direction is achieved.

Preferably, the axes of the drive devices in the installation position can be situated above the axis of the transmission input shaft. The installation position is always referenced in the following. During installation, the hybrid transmission device can also be upside down. Such positions are irrelevant for the following description, however. While the axially parallel arrangement also makes it possible for one of the drive devices to be located below the axis of the transmission input shaft, it is advantageously provided that the drive devices and, thereby, their axes are positioned above the transmission input shaft. In this arrangement, the packing density can be maximized.

In addition, the axes of the drive devices in the installation position can be situated on both sides of the axis of the transmission input shaft. Therefore, one of the drive devices and/or its axis are/is situated to the left of the axis of the transmission input shaft and the other(s) are/is situated to the right of the axis. Reference is made here to the view of the axes in cross-section.

Preferably, it can be provided that the axes of the drive devices in the installation position are arranged symmetrically with respect to the axis of the transmission input shaft. In particular, the axes of the drive devices are to be symmetrically arranged with respect to distance and angular position, wherein the angle is based on the perpendicular. The drive devices can be counter-rotatingly arranged without ruining the symmetrical arrangement, since the position of the axes is all that matters here.

Preferably, the axes of the drive devices in the installation position can be situated above the axes of one or multiple countershaft(s) and/or one or multiple output shaft(s). The drive devices are therefore situated above the aforementioned components of the spur gear drive arrangement. Alternatively, it can therefore be said that the axes of the drive devices in the installation position are the uppermost axes of the hybrid transmission device.

Preferably, the drive devices can be arranged offset in the circumferential direction. The circumferential direction is established with respect to the longitudinal axis of the transmission input shaft, which, by definition, is considered in the present invention to be the longitudinal axis of the hybrid transmission device.

It is preferred when the drive devices are arranged at least partially overlapping in the axial direction. Preferably, the overlap in the axial direction can be more than seventy-five percent (75%). If the drive devices should be of unequal length, the shorter drive device is used as the basis for calculating the overlap. The overlap is determined with reference to the housing of the drive devices. The output shaft of the drive devices is not taken into account.

The drive devices can be arranged in the axial direction preferably at the same level as the gear change transmission. Preferably, the overlap in the axial direction can be more than seventy-five percent (75%). Advantageously, the overlap in the axial direction is one hundred percent (100%). Here, the overlap is determined with reference to the housing of the drive devices and, in particular, of the housing of the longer drive device. The output shaft of the drive devices is not taken into account.

Preferably, the first drive device can be rotationally fixed to the first transmission input shaft, in particular attached to the first transmission input shaft. When the first transmission input shaft is arranged in such a way that it is connectable to the internal combustion engine by a single shift element, the first drive device can be operated as a generator in many operating situations.

Advantageously, the second drive device can be rotationally fixed to the second transmission input shaft, in particular attached to the second transmission input shaft. When the second transmission input shaft is arranged in such a way that the second transmission input shaft is connectable to the internal combustion engine by two shift elements and, in particular, via the first transmission input shaft, the second drive device can be utilized in many operating situations as a parallel drive source with respect to the internal combustion engine.

Preferably, the first drive device and/or the second drive device can be designed as an electric motor. Electric motors are widespread in hybrid transmission devices.

Alternatively or additionally, the first drive device and/or the second drive device can be designed as a fluid power machine. In addition to electric motors, there are other prime movers, the utilization of which in hybrid transmission devices is conceivable. The first and second drive devices can also be operated as motors, i.e., in a manner that consumes energy, or as generators, i.e., in a manner that converts energy. In the case of a fluid power machine, the energy accumulator is, for example, a pressure reservoir. The energy conversion then consists of converting the energy from the internal combustion engine into a pressure build-up.

Advantageously, the first drive device and the second drive device can be power-shifted. A powershift is understood here, as usual, to mean that no interruption of tractive force occurs at the output of the hybrid transmission device during a gear change, for example, of the first drive device. A reduction of the torque present at the output is possible, but a complete interruption is not.

As a result, the motor vehicle can be continuously driven in large speed ranges, for example, exclusively electrically, wherein the ratio, i.e., the gear, is selected in each case so as to be optimized with respect to the rotational speed and torque of the drive device.

Preferably, the second drive device can output torque to the drive output while the first drive device is shifted. In other words, the gear step is changed, via which the first drive device transmits torque to the drive output.

Preferably, the first drive device can output torque to the drive output while the second drive device is shifted. This means, the gear step is changed, via which the second drive device transmits torque to the drive output. It may therefore also be stated that the drive devices are power shiftable with each other. The internal combustion engine therefore does not need to be started for a gear change during electric travel.

Preferably, at least one of the drive devices can be attached to the transmission via a P3 attachment. Advantageously, both drive devices are attached to the transmission via this attachment. In a P3 attachment, the drive devices engage at the transmission between the input shaft and the output shaft.

Advantageously, both drive devices can be operatively connected to a differential via, at most, four meshing points. As a result, good efficiency is achieved.

Advantageously, a clutch can be present for connecting the first transmission input shaft to an internal combustion engine. The clutch is advantageously arranged at the end of the first transmission input shaft facing the outer side and the internal combustion engine of the hybrid transmission device.

In addition, a clutch can be present for connecting the second transmission input shaft to the internal combustion engine. The clutch is advantageously arranged at the end of the second transmission input shaft facing the outer side and the internal combustion engine of the hybrid transmission device.

Preferably, a connecting clutch can be provided for connecting the first transmission input shaft and the second transmission input shaft. The connecting clutch is utilized for coupling the sub-transmission. However, the connecting clutch is also a clutch for connecting the second transmission input shaft to the internal combustion engine, wherein the connection extends via the first transmission input shaft.

Preferably, the connecting clutch can be arranged at the end of the second transmission input shaft facing the transmission. As a result, it becomes possible to provide two clutches on the engine side, with which the first transmission input shaft as well as the second transmission input shaft are connectable to the internal combustion engine. As a result, it becomes possible, for example, to provide an electric motor-operated crawler gear or also to operate both electric motors together and, alternately, as generators.

Advantageously, the connecting clutch can be designed as part of a two-sided engagement device. The connecting clutch, due to positioning, is integratable into a two-sided engagement device.

In the present invention, an engagement device is understood to be an arrangement with one or two shift element(s). The engagement device is designed to be one-sided or two-sided. A shift element can be a clutch or a gearshift clutch. A clutch is utilized for connecting two shafts in a rotationally fixed manner and a gearshift clutch is utilized for rotationally fixing a shaft to a hub rotatably mounted thereon, for example, an idler gear. The connecting clutch, therefore, is designed as a gearshift clutch and, preferably, also as part of a gearshift clutch and is referred to as a clutch only because the gearshift clutch connects two shafts to each other. The clutches for connecting the transmission input shafts to the internal combustion engine connect the particular transmission input shaft to a crankshaft of the internal combustion engine.

Preferably, at least a portion of the clutches and/or gearshift clutches can be designed as dog clutches. In particular, all clutches and gearshift clutches can be designed as dog clutches.

Advantageously, at least one engagement device can be arranged on the first transmission input shaft. Preferably, at least two, in particular precisely two, engagement devices can be arranged on the first transmission input shaft. This can be advantageously designed as a two-sided engagement device. Alternatively, a one-sided engagement device and a two-sided engagement device can be provided. Advantageously, the engagement devices enclose the second transmission input shaft.

One of the engagement devices on the first transmission input shaft preferably includes a gearshift clutch and a clutch.

Advantageously, the second transmission input shaft can be designed to be engagement device-free and/or idler gear-free. Preferably, at least one fixed gear can be arranged on the second transmission input shaft. In particular, at least two, in particular precisely two, fixed gears can be arranged on the second transmission input shaft.

Preferably, at least one, in particular precisely one, idler gear can be arranged on the first transmission input shaft.

Preferably, at least two, in particular precisely two, fixed gears can be arranged on the first transmission input shaft.

Advantageously, one fixed gear and one idler gear can be associated with each forward gear step and, in fact, a single fixed gear and a single idler gear in each case. In addition, each fixed gear and idler gear can always be unambiguously associated with a single forward gear step, i.e., there are no winding-path gears by utilizing one gearwheel for multiple gears. Nevertheless, the internal-combustion-engine forward gears two and four can be considered to be winding-path or coupling gears, as described below, since the first transmission input shaft is interconnected during the formation of the gears.

In one preferred example embodiment, the hybrid transmission device and/or the transmission can include precisely four two-sided engagement devices for producing five internal-combustion-engine gear stages, in particular forward gear stages. The connecting clutch advantageously forms a part of one of the two-sided engagement devices.

Preferably, a differential can be arranged in the axial direction at the level of one or two clutches for connecting a transmission input shaft to the internal combustion engine. Advantageously, a gearwheel for attaching the differential can be arranged axially externally on a countershaft. The attachment can preferably take place at the side of the internal combustion engine.

Preferably, the hybrid transmission device can include at least one, in particular precisely one, countershaft. In the case that a single countershaft is utilized, a single point of attachment to the differential is present. As a result, installation space can be saved, which is the case in the radial direction as well as in the axial direction.

Preferably, at least two, in particular precisely two, engagement devices can be arranged on the countershaft. In addition, advantageously, precisely four idler gears can be arranged on the countershaft. Advantageously, all the engagement devices on the countershaft can be designed to be two-sided.

The engagement devices arranged on the countershaft can be arranged offset in the axial direction with respect to one or multiple engagement device(s) on one of the transmission input shafts, in particular the first transmission input shaft. In particular, the engagement device arranged on the countershaft can enclose an engagement device on the first transmission input shaft in the axial direction. This means, the engagement device arranged on the countershaft and the engagement device on the first transmission input shaft are not only axially offset, but rather that the one engagement device on the countershaft is located to the left of the engagement device on the first transmission input shaft and the other to the right thereof, as viewed in a gear set scheme. When the transmission is viewed in the direction longitudinally to the transmission, the one engagement device is situated in front of the engagement device and the other behind the engagement device on the first transmission input shaft. The enclosed engagement device is advantageously arranged at one end of the second transmission input shaft.

Advantageously, all shift elements of the engagement devices on the countershaft can be designed as gearshift clutches.

Preferably, at least one, in particular precisely one, fixed gear can be located on the countershaft for forming a forward gear step. In addition, a fixed gear can be located on the countershaft for establishing a connection to the differential. However, this is not a fixed gear for forming a forward gear step.

Advantageously, a single fixed gear for forming a forward gear step can be arranged on the countershaft, and at least one idler gear can be arranged on both sides of the fixed gear. Preferably, at least two, in particular precisely two, idler gears are located on both sides of the fixed gear.

In addition, the hybrid transmission device can include a control device. The control device is designed for controlling the transmission as described.

Example aspects of the invention also relate to a motor vehicle with an internal combustion engine and a hybrid transmission device. The motor vehicle is distinguished by the fact that the hybrid transmission device is designed as described.

Advantageously, the hybrid transmission device is arranged in the motor vehicle as a front-transverse transmission device.

Preferably, the motor vehicle includes a control device for the open-loop control of the hybrid transmission device. The control device can therefore be part of the hybrid transmission device, although the control device does not need to be part of the hybrid transmission device.

Preferably, a battery is arranged in the motor vehicle, which allows for an electric operation of the motor vehicle for at least fifteen (15) minutes. Alternatively, for a purely electric operation, the internal combustion engine, with one of the electric motors as a generator, can generate current, which goes directly to the other electric motor.

In addition, the motor vehicle can include a pressure reservoir. This can be utilized for operating a fluid power machine.

### BRIEF DESCRIPTION OF THE DRAWINGS

Further advantages, features, and details of the invention result from the following description of exemplary embodiments and figures, in which:

FIG. 1 shows a motor vehicle;

FIG. 2 shows a first gear set scheme;

FIG. 3 shows a circuit diagram;

FIG. 4 shows a first shift pattern;

FIG. 5 shows the hybrid transmission device in a side view;

FIG. 6 shows a circuit diagram for a crawler gear;

FIG. 7 shows a circuit diagram for a hybrid gear;

FIG. 8 shows a representation of a first gear change over time;

FIG. 9 shows a representation of a second gear change over time;

FIG. 10 shows a second gear set scheme;

FIG. 11 shows a second shift pattern; and

FIG. 12 shows a third gear set scheme.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

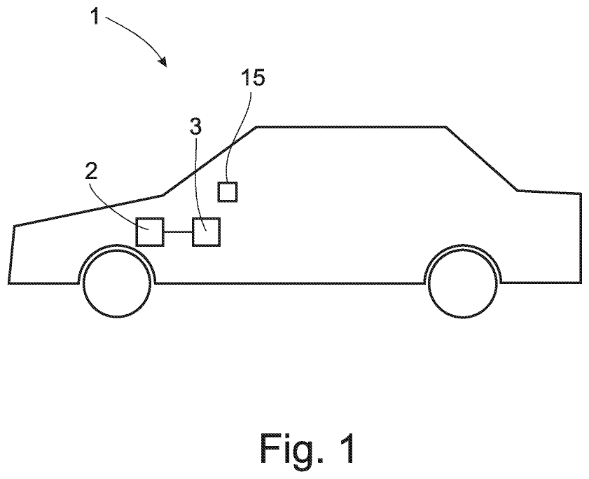

FIG. 1 shows a motor vehicle 1 with an internal combustion engine 2 and a hybrid transmission device 3. The hybrid transmission device 3 also includes, as described in greater detail further below, electric motors and a clutch device, and so the hybrid transmission device 3 can be installed as an assembly unit. This is not absolutely necessary, however. In principle, the gear set can form an assembly unit even without a previously connected clutch assembly and the electric motors. A control device 15 is provided for the open-loop control of the hybrid transmission device 3. The control device 15 can be part of the hybrid transmission device 3 or of the motor vehicle 1.

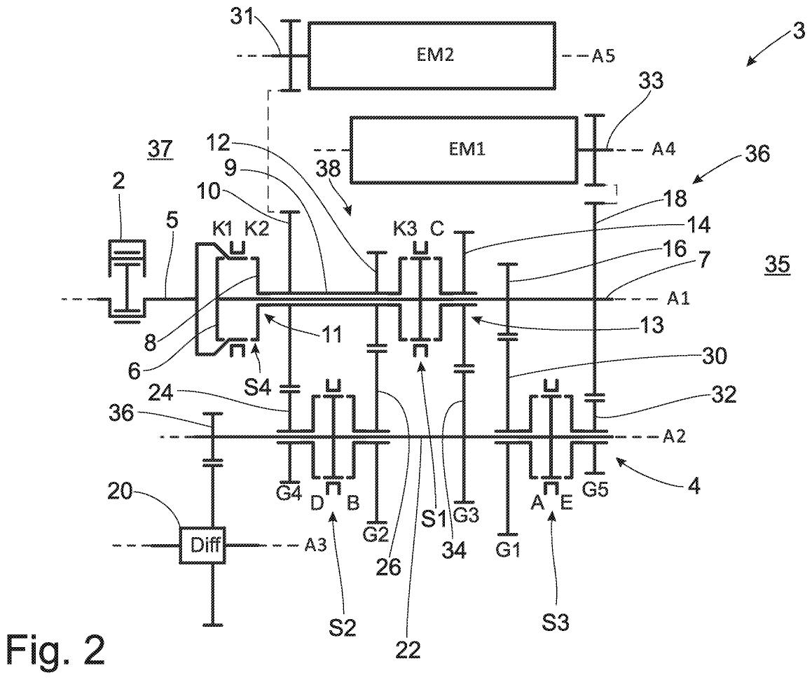

FIG. 2 shows the hybrid transmission device 3 and, in particular, the gear change transmission 4, in the form of a gear set scheme. In the following, the hybrid transmission device 3 will be described starting from the internal combustion engine 2. Two clutches K1 and K2 are attached, on the input-side, to a crankshaft 5. An output part 6 of the clutch K1 is connected to a first transmission input shaft 7, and an output part 8 of the clutch K2 is connected to a second transmission input shaft 9. Two fixed gears 10 and 12 are arranged on the second transmission input shaft 9. The fixed gear 10 is the fixed gear of the fourth gear step G4 and the fixed gear 12 is the fixed gear of the second gear step G2.

The second transmission input shaft 9 has two ends, namely one end 11 pointing toward the outer side of the hybrid transmission device 3 and one end 13 pointing toward the inner side of the hybrid transmission device 3.

An engagement device S1, mounted on the transmission input shaft 7, with a clutch K3 and a gearshift clutch C follows. By the gearshift clutch C, an idler gear 14 can be rotationally fixed to the transmission input shaft 7. The idler gear 14 is the idler gear of the third gear step G3.

On the first transmission input shaft 7, the fixed gears 16 and 18 follow, wherein the fixed gear 16 is the fixed gear of the first gear step G1 and the fixed gear 18 is the fixed gear of the fifth gear step G5.

The second transmission input shaft 9 is therefore designed to be shift element-free and idler gear-free. Two engagement devices S1 and S4 are arranged on the first transmission input shaft 7. The engagement device S1 includes the clutch K3 and the gearshift clutch C and, therefore, is designed to be two-sided.

The axis of rotation of the first transmission input shaft 7 and of the second transmission input shaft 9 is labeled with A1.

The hybrid transmission device 3 includes a single countershaft 22 for connection to a differential 20 and to form the gear stages or gear steps. Two engagement devices S2 and S3 are arranged on the countershaft 22 with the gearshift clutches A, B, D, and E for connecting the idler gears 24, 26, 30, and 32 to the countershaft 22. As the only gear-implementing fixed gear, the fixed gear 34 is located between the idler gears 24, 26, 30, and 32 on the countershaft 22. The assignment to the gear steps results on the basis of the gear step numbers G1 through G5 below the gearwheels arranged on the countershaft 22. The fixed gear 36 is not a gear-implementing fixed gear. The fixed gear 36 connects the countershaft 22 to the differential 20 as a drive output constant. On the basis of this scheme, the following can be determined with respect to the forward gear steps: one fixed gear and one idler gear are associated with each forward gear step and, in fact, a single fixed gear and a single idler gear in each case. Each fixed gear and idler gear are always unambiguously associated with a single forward gear step, i.e., there are no winding-path gears by utilizing one gearwheel for multiple gear steps. Nevertheless, the forward gear steps G2 and G4 can be considered to be coupling gears, since the first transmission input shaft 7 is interconnected during the formation of the forward gear steps G2 and G4.

The electric motors EM1 and EM2 are attached as shown and, in fact, at the axially external gearwheels 10 and 18. As a result, it is possible to attach the electric motors EM1 and EM2 without additional gearwheels on one of the transmission input shafts 7 and 9, as the result of which installation space is saved. In particular, due to the attachment of the electric motors EM1 and EM2 at the axially outermost gearwheels 10 and 18, an axially extremely short hybrid transmission device 3 can be created.

The electric motors EM1 and EM2 are arranged in parallel to the transmission input shaft 7 and the electric motors EM1 and EM2 have the output at opposite sides. This means, as shown in FIG. 2, the output and/or the output shaft 33 of the electric motor EM1 points toward the end 35 of the gear change transmission 4 facing away from the motor and the output shaft 31 of the electric motor EM2 points toward the end 37 of the gear change transmission 4 facing the motor. In FIG. 2, one end therefore points toward the left and one end points toward the right. The electric motors EM1 and EM2 are arranged partially overlapping in the axial direction, and so the hybrid transmission device 3, in the area of the electric motors EM1 and EM2, takes up only approximately the length occupied by a single electric motor. Due to the above-described arrangement of the shift elements S1, S2, S3, and S4 and the design of the reverse gear without a reversing gearwheel, a length of the hybrid transmission device 3 of slightly more than thirty centimeters (30 cm) is made possible.

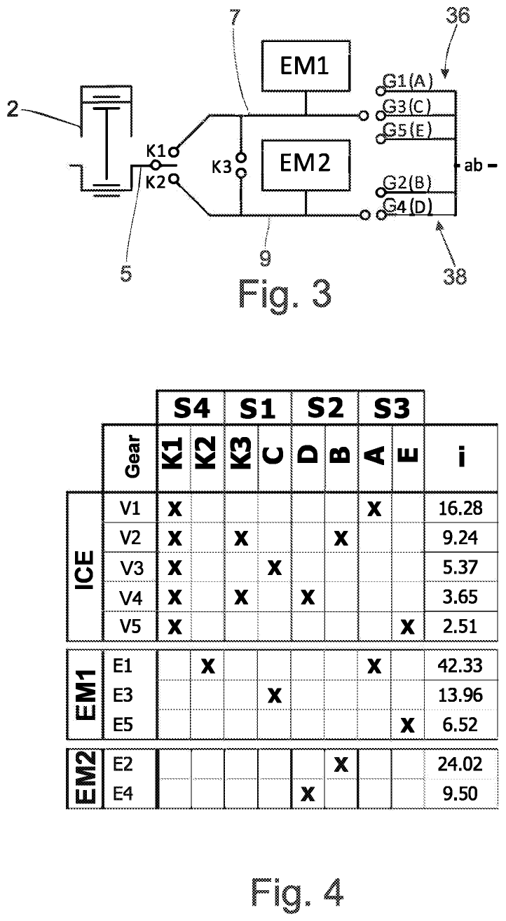

FIG. 3 shows a circuit diagram of the hybrid transmission device 3 according to FIG. 2, from which it arises, for example, that the clutch K3 connects the input shafts 7 and 9 of the sub-transmissions 36 and 38. The sub-transmission 36 includes the odd gears and the sub-transmission 38 includes the even gears.

FIG. 4 shows a first shift pattern for the hybrid transmission device 3 according to FIG. 2, in which it is apparent that the clutch K1 can be engaged in all internal-combustion-engine gears V1 through V5. This also applies for the internal-combustion-engine forward gears V1 through V4 of the embodiments described further below. In contrast to a typical dual clutch transmission, in which the clutches K1 and K2 are alternately disengaged and engaged during the shifting of the forward gears, the even internal-combustion-engine gears V2, V4 are achieved in that the clutches K1 and K3 are engaged. A changeover between the sub-transmissions therefore preferably takes place via the disengagement and engagement of the clutch K3. In contrast to typical dual clutch transmissions, the utilization of the clutches is therefore implemented in a deviating manner. As is already also apparent from FIG. 2, precisely one of the gearshift clutches A through E is engaged and in the power flow in each of the internal-combustion-engine forward gears.

The described hybrid transmission device 3 has several functional advantages. For example, due to the described arrangement, both electric motors can be operated as a motor and as a generator. As a result, it is possible, for example, to provide a crawler gear, which is entered as gear E1 in the shift pattern for the electric motor EM1. It has a ratio of over forty (40). For this purpose, the clutch K2 and the gearshift clutch A are engaged. Since the crawler gear produced with the hybrid transmission device 3 is formed via driving with the electric motor EM1, the electric motor EM2 can be utilized as a generator in the meantime. In the crawler gear E1, therefore, the electric motor EM1 is utilized as a motor and the electric motor EM2 is utilized as a generator.

This is also the sole utilization of the clutch K2.

Of course, the crawler gear E1 can also be operated in a battery electric manner. In this case, only the gearshift clutch A is necessarily engaged. Clutch K2 can be disengaged.

In each of the electric motor-operated forward gears E3 and E5, one of the gearshift clutches C or E is engaged, as the result of which the described ratios are produced. In these gears as well, it is possible to engage clutch K2 and utilize electric motor EM2 as a generator.

With the electric motor EM2, two electric motor-operated forward gears E2 and E4 can also be produced. For this purpose, only the second transmission input shaft 9 and the shift element S2, with one of the clutches B or D in each case, are utilized. In these gears, it is possible, therefore, to engage clutch K1 and utilize electric motor EM1 as a generator.

By the two electric motors EM1 and EM2, five electric forward gears, including one crawler gear, can therefore be formed, wherein only one of the two sub-transmissions 36 or 38 must be integrated in each case.

The gearshift clutches A through E and at least the clutches K2 and K3 are advantageously designed as dog clutches. Preferably, the clutch K1 is also designed as a dog clutch. An internal-combustion-engine gear change under load takes place by utilization of the electric motors EM1 and/or EM2.

The gear change from the internal-combustion-engine gear V1 into the internal-combustion-engine gear V2 is described in the following. In the internal-combustion-engine forward gear V1, the clutch K1 and the gearshift clutch A are engaged. In addition, the gearshift clutch B can be engaged, but not yet loaded. Thereupon, the electric motor EM1 is operated as a generator in such a way that the cumulative torque of the internal combustion engine 2 and of the electric motor EM1 is approximately equal to zero (0), while the electric motor EM2 applies the torque at the drive output. The torque reduction or increase can take place linearly in each case. As a result, the gearshift clutch A becomes load-free and can be disengaged.

Thereafter, the electric motor EM1 and the internal combustion engine 2 synchronize the first transmission input shaft 7, via which no torque is transmitted in this moment, with respect to the second transmission input shaft 9, and so the clutch K3 can be engaged. Finally, a load change from the electric motor EM2 to the internal combustion engine 2 takes place, as the result of which the internal-combustion-engine forward gear V2 is achieved. In the internal-combustion-engine second forward gear V2, the gearshift clutch B is engaged. Therefore, the electric motor EM2 can be operated as a generator in this case, provided the gearshift clutch B is to be disengaged again.

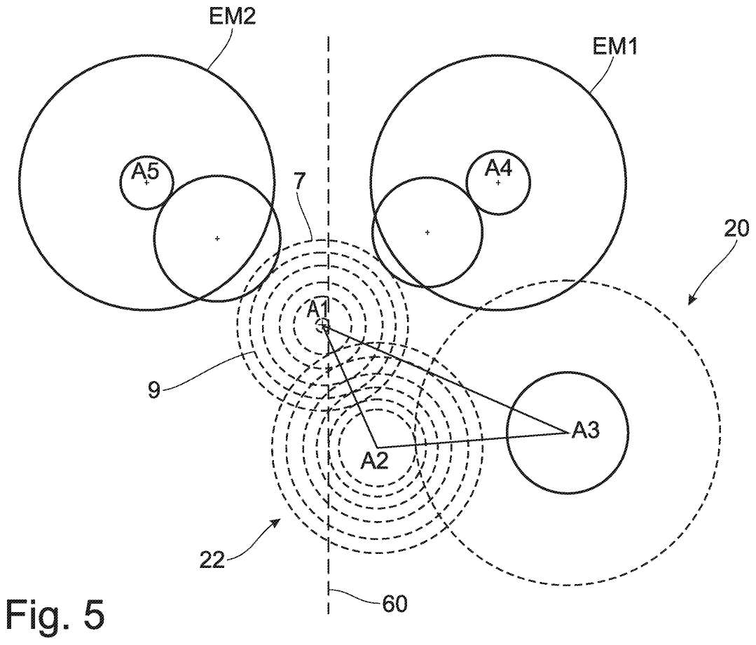

FIG. 5 shows a side view of the transmission according to FIG. 2. The axes A4 and A5 of the electric motors EM1 and EM2 are arranged above and laterally with respect to the axis A1 of the first transmission input shaft 7 and also of the second transmission input shaft 9. The axis A2 of the countershaft 22 and the axis A3 of the differential are advantageously situated below the axis A1 of the first transmission input shaft 7. The axes A4 and A5 are arranged symmetrically with respect to the axis A1 in such a way that the distance of the axes A4 and A5 to the axis A1 is identical and the angle with respect to the perpendicular 60 is also identical.

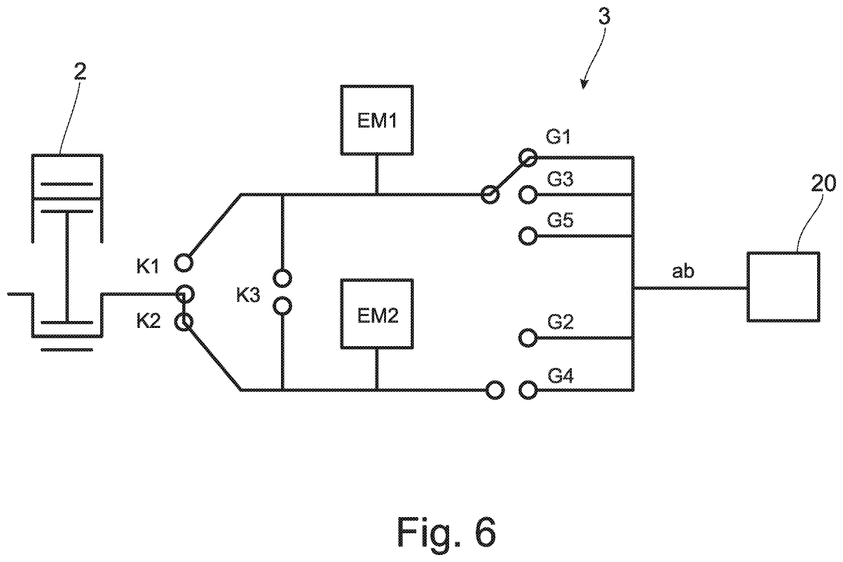

FIG. 6 shows the hybrid transmission device 3 and the motor vehicle 1 as a circuit diagram in the crawler gear, wherein the electric motor EM1 is utilized not only as a main drive source, but rather even as the sole drive source of the motor vehicle 1. The gearshift clutch A is engaged. The first gear step G1 is therefore provided for transmitting torque to the drive output. Since the electric motor EM1 is the drive source, this is equivalent to the utilization of the electric gear E1. Due to the engagement of the clutch K2, the internal combustion engine 2 can drive the electric motor EM2. The electric motor EM2 is therefore operated as a generator and, in this way, can generate current for inching operations of longer duration. Neither the internal combustion engine 2 nor the electric motor EM2 are connected to the drive output in this case.

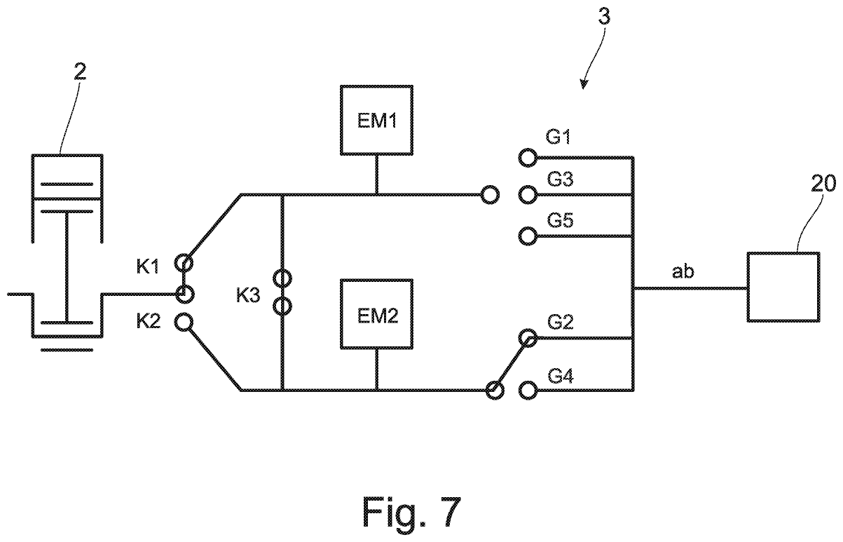

FIG. 7 shows a hybrid gear H22, in which the internal combustion engine and also the electric motor EM2 are connected to the drive output via the gear-step gears 12 and 26 of the second gear step G2. The clutch K3 is engaged in order to connect the internal combustion engine 2 to the gear-step gears 12 and 26. Due to the engaged clutch K1, the electric motor EM1 is also connected to the internal combustion engine 2 and can be operated as a generator, as necessary. A portion of the power of the internal combustion engine 2 can therefore be utilized for the operation of the electric motor EM1 as a generator and a portion can be output to the drive output of the hybrid transmission device 3.

The electric motor EM1 does not need to be continuously operated as a generator, as described. Rather, a change-over can be carried out between the electric motors EM1 and EM2.

With regard to the nomenclature, the first number of the hybrid gear designates the internal-combustion-engine gear and the second number designates an electric motor-operated gear. It is not expressed whether the first electric motor is operated as a motor or as a generator, for example, in the hybrid gear H32.

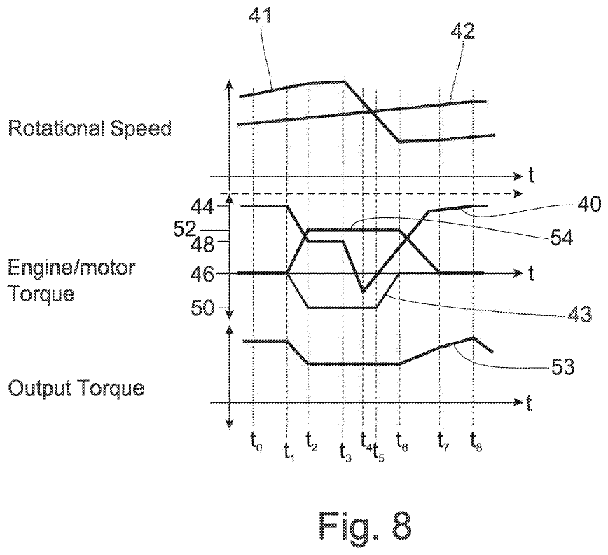

FIG. 8 shows a representation of a gear change from a hybrid gear H22 to H32 over time. A change-over from the internal-combustion-engine gear V2 to V3 is therefore carried out, while the electric-motor gear E2 remains.

Rotational speeds are represented in the upper section, engine/motor torques are represented in the middle section, and the output torque is represented in the lower section.

At the point in time to, a gear shift is present as shown in FIG. 7. The internal combustion engine 2 and the electric motor EM2 provide output via the gear-step gears of the second gear to the drive output. The engine/motor speed 41 of the internal combustion engine 2 and of the electric motor EM1 coupled thereto and the motor speed 42 of the electric motor EM2 are at their initial values. Due to a request for a gear change, at the point in time t₁, the engine torque of the internal combustion engine 2, which is represented in the curve 40, is reduced. Simultaneously, the electric motor EM1, the curve 43 of which therefore extends below zero (0), is operated as a generator. The initial values 44 and 46 are reduced to the target values 48 and 50 by the point in time t₂.

In addition, at the point in time t₁, the electric motor EM2 begins to ramp up, starting from its start value, to a target value 52. The motor torque of the electric motor EM2 is represented in the curve 54. If the target values 48 and 50 are selected in such a way that the target values 48 and 50 have the same amount, this means the cumulative torque of the internal combustion engine 2 and the electric motor EM1 is equal to zero (0), as the result of which the clutch K3 becomes load-free and can be disengaged. This disengagement of the clutch K3 takes place between the points in time t₂ and t₃.

In this interval, i.e., between the points in time t₂ and t₃, only the electric motor EM2 drives the motor vehicle 1, since the torques of the internal combustion engine 2 and the electric motor EM1 cancel each other out as described. Starting at the point in time t₃, the torque of the internal combustion engine 2 is reduced further, in order to bring the rotational speed of the transmission input shaft 7 to the rotational speed, at which a ratio with respect to the rotational speed of the countershaft 22 is reached, at which the gearshift clutch C can be engaged.

Between the points in time t₂ and t₆, in which only or mainly the electric motor EM2 drives, the output torque 53 is lower than in the case of an assistance or take-over by the internal combustion engine 2.

Starting at the point in time t₅, the generator operation of the electric motor EM1 begins to end. The electric motor EM1 is ramped up to the initial value and/or the initial torque 46. Simultaneously, the torque of the internal combustion engine 2 is also increased to its initial value 44. As soon as the electric motor EM1 has ended the operation as a generator at the point in time t₆, the torque output of the electric motor EM2 is reduced and, in fact, also back to the initial value. At the point in time t₇, the torque output of the electric motors EM1 and EM2 is at the initial value again. The torque output of the internal combustion engine 2 is increased slightly up to the point in time t₈.

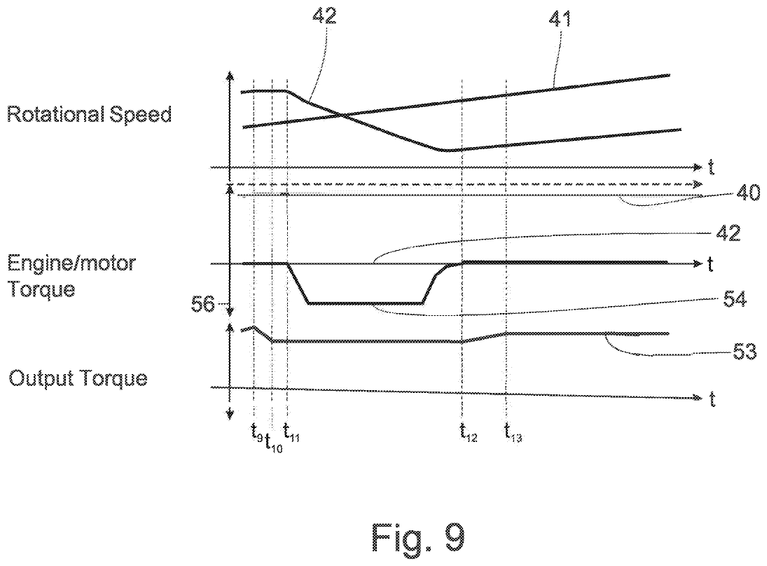

FIG. 9 shows the gear change of a hybrid gear starting from the internal-combustion-engine gear V3 and the electric gear E2 into the electric gear E4. At the point in time t₉, the shift elements are located as the shift elements are at the point in time t₈, i.e., only the rotational speeds 41 and 42 may have changed. At the point in time t₁₀, the gearshift clutch B is disengaged. The disengagement has ended by the point in time t₁₁. Starting at this point, the motor torque of the electric motor EM2 is guided to a negative value, in order to adapt, by operation as a generator, the rotational speed of the transmission input shaft 9 to the rotational speed of the transmission input shaft 7 in such a way that the idler gear 24 has the same rotational speed as the shift element 52. The rotational speeds of the transmission input shaft 7 and of the transmission input shaft 9 are therefore not to become identical, but rather are to be adapted in such a way that the rotational speeds of the idler gear 24 and of the engagement device S2 are identical or are identical except for a predefined difference. Thereupon, starting at the point in time t₁₂, the gearshift clutch D can be engaged, as the result of which the electric motor EM2 outputs torque to the drive output via the gear-step gears of the fourth gear G4. At the point in time t₁₃, the gearshift clutch D is engaged. Starting at this point in time, the internal combustion engine 2 transmits torque via the gear-step gears of the third gear G3 and the electric motor EM2 transmits torque via the gear-step gears of the fourth gear G4. The curve 53 of the output torque shows only a slight downturn, since the gear change of the electric motor EM2 is assisted by the internal combustion engine 2 in the time period between the points in time t₁₁ and t₁₂, in which no torque from the electric motor EM2 reaches the drive output.

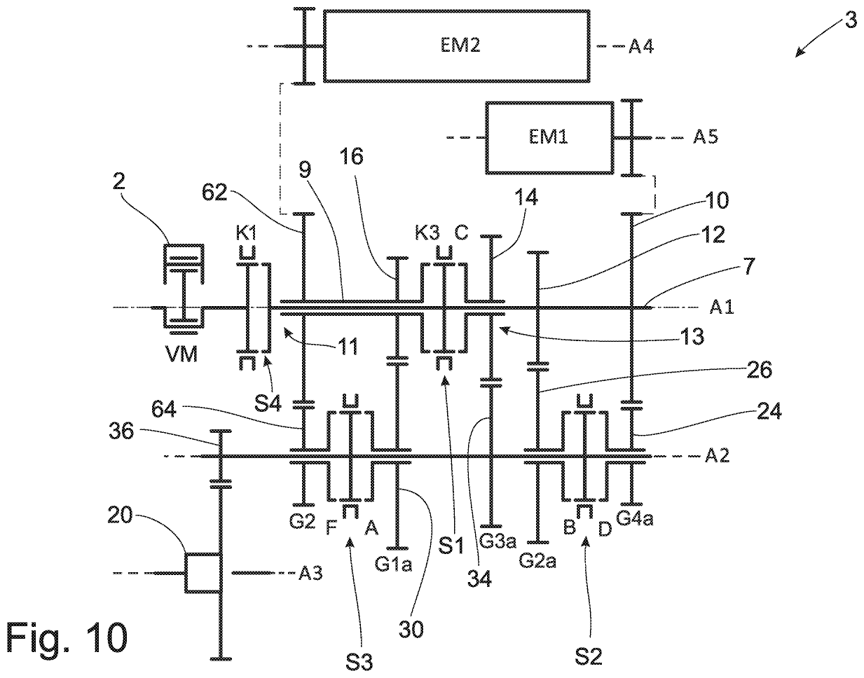

FIG. 10 shows a configuration as an example alternative to FIG. 2, wherein most features and functions are similar to those described with respect to FIGS. 2 through 9. Identical reference numbers label identical components. The first transmission input shaft, which is designed as a solid shaft, also has, for example, the reference character 7. The second transmission input shaft, which is designed as a hollow shaft, has the reference character 9.

In contrast to FIG. 2, however, the clutch K2 and the gear-step gears 18 and 32 of the fifth gear step G5 are omitted. In their place, the gear-step gears 62 and 64 of a purely electrically utilized gear step GE2 have been added. While the gears labeled with a “G” can be electric, internal-combustion-engine, and hybrid gear steps, this is limited to an electric gear step with the gear GE2.

The crawler gear E1 can be implemented via the gear step G1, wherein, in the example embodiment according to FIG. 10, the second transmission input shaft 9 and the second electric motor EM2 are utilized as a drive.

The electric motors EM1 and EM2 are power shiftable with each other in this configuration as well.

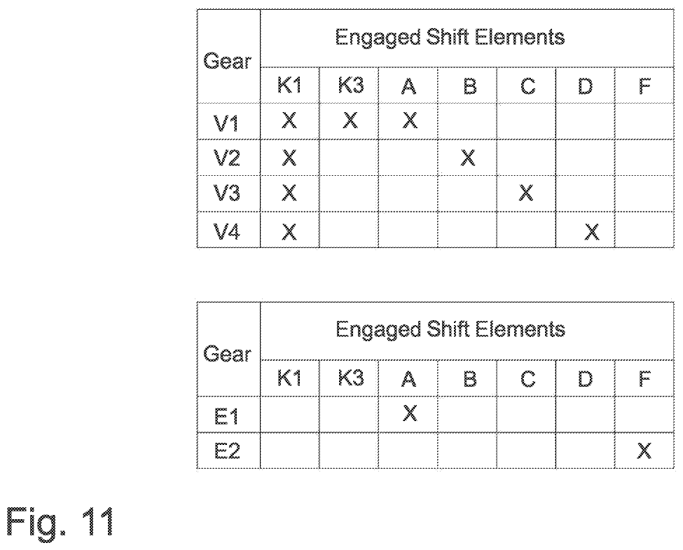

In contrast to FIGS. 2 through 4, however, only four internal-combustion-engine forward gears V1, V2, V3, and V4 can be implemented, as shown in FIG. 11. The internal-combustion-engine forward gears V1, V2, V3, and V4 and the electric forward gear E1 are formed via the corresponding mechanical gear stages G1, G2, G3, and G4, i.e., E1 and V1 with G1, V2 with G2, etc. The electric gear E2 has separate gear-step gearwheels 62 and 64, however, and does not utilize the gear-step gearwheels 12 and 26 of the gear step G2, which, at this point, deviates from the nomenclature utilized otherwise in the present application.

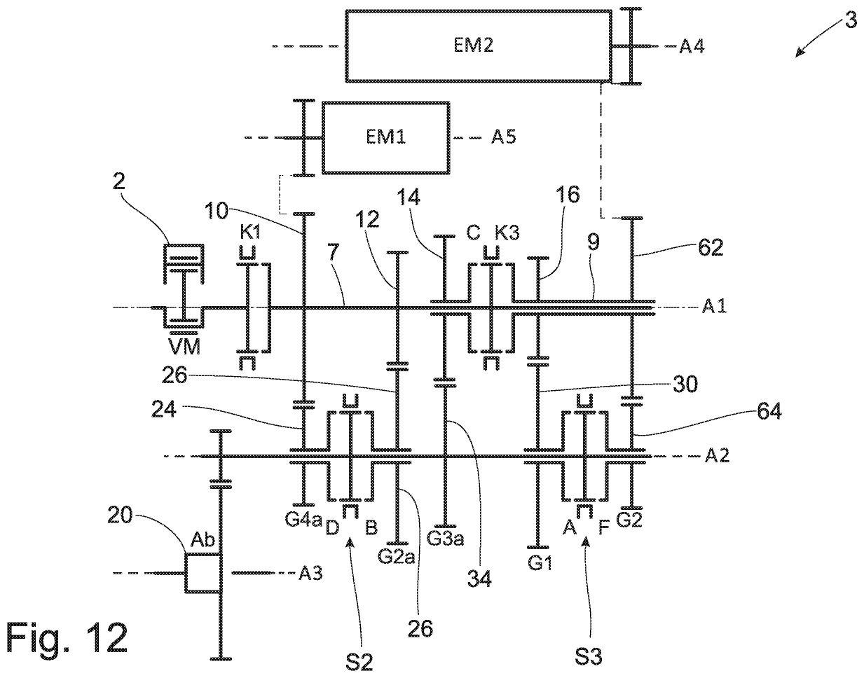

FIG. 11 shows a corresponding shift pattern, which is associated with FIGS. 10 and 12. The particular engaged shift elements are marked by “X”.

The shift element F is the shift element of the gear step GE2, which is utilized only with the electric motor EM2.

FIG. 12 shows the hybrid transmission device 3 according to FIG. 10, wherein the hybrid transmission device 3 in FIG. 12 was designed as a mirror image with respect to the central axis, which extends through the gearwheels 14 and 34 of the gear step G3. From a purely functional perspective, the hybrid transmission devices 3 according to FIGS. 10 and 12 do not differ.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 motor vehicle
2 internal combustion engine
3 hybrid transmission device
4 gear set
5 crankshaft
6 output part
7 first transmission input shaft
8 output part
9 second transmission input shaft
10 fixed gear
11 end
12 fixed gear
13 end
14 idler gear
15 control device
16 fixed gear
18 fixed gear
20 differential
22 countershaft
24 idler gear
26 idler gear
30 idler gear
31 output shaft
32 idler gear
33 output shaft
34 fixed gear
35 end facing away from the motor
36 sub-transmission
37 end facing the motor
38 sub-transmission
40 curve
41 motor speed
42 motor speed
43 curve
44 initial value
46 initial value
48 target value
50 target value
52 target value
53 output torque
54 curve
60 perpendicular
K1 clutch
K2 clutch
K3 clutch
S1 engagement device
S2 engagement device
S3 engagement device
S4 engagement device
A gearshift clutch
B gearshift clutch
C gearshift clutch
D gearshift clutch
E gearshift clutch
EM1 electric motor
EM2 electric motor
A1 axis
A2 axis
A3 axis
A4 axis
A5 axis

1-14. (canceled)

15. A hybrid transmission device (3), comprising
two drive devices (EM1, EM2); and
a transmission (4) comprising a first transmission input shaft (7) and a second transmission input shaft (9), the second transmission input shaft (9) mounted on the first transmission input shaft (7),
wherein at least one gearwheel (10, 12, 14, 16, 18) for forming a forward gear (V1, V2, V3, V4, V5, E1, E2, E3, E4, E5) is arranged on each of the first and second transmission input shafts (7, 9), and
wherein a first drive device (EM1) of the two drive devices (EM1, EM2) is attached at a gearwheel (18) on the first transmission input shaft (7), and a second drive device (EM2) of the two drive devices (EM1, EM2) is attached at a gearwheel (10) on the second transmission input shaft (9).

16. The hybrid transmission device of claim 15, further comprising a clutch (K1) configured for selectively connecting the first transmission input shaft (7) to an internal combustion engine (2).

17. The hybrid transmission device of claim 15, wherein further comprising a clutch (K2) configured for selectively connecting the second transmission input shaft (9) to an internal combustion engine (2).

18. The hybrid transmission device of claim 15, further comprising a connecting clutch (K3) configured for selectively connecting the first transmission input shaft (7) and the second transmission input shaft (9).

19. The hybrid transmission device of claim 15, wherein one or more of a plurality of clutches (K1, K2, K3) and a plurality of gearshift clutches (A, B, C, D, E) is a dog clutch.

20. The hybrid transmission device of claim 15, further comprising precisely four two-sided engagement devices (S1, S2, S3, S4) configured for producing five internal-combustion-engine forward gear steps (V1, V2, V3, V4, V5, E1, E2, E3, E4, E5).

21. The hybrid transmission device of claim 15, further comprising a connecting clutch (K3) configured for selectively connecting the first transmission input shaft (7) and the second transmission input shaft (9), the connecting clutch (K3) mounted on the first transmission input shaft (7).

22. The hybrid transmission device of claim 15, further comprising a plurality of engagement devices (S1, S2, S3, S4), wherein precisely two of the engagement devices (S1, S2, S3, S4) are arranged on the first transmission input shaft (7).

23. The hybrid transmission device of claim 15, further comprising precisely one countershaft (22).

24. The hybrid transmission device of claim 23, wherein each of the two drive devices (EM1, EM2) is connected to the respective gearwheel (10, 18) situated axially outward on one of the first and second transmission input shafts (7, 9).

25. The hybrid transmission device of claim 15, wherein one of the two drive devices (EM2) is operatively connected to a gearwheel (10) of the highest even gear step (G4), and the other of the two drive devices (EM1) is operatively connected to a gearwheel (18) of the highest odd gear step (G5).

26. The hybrid transmission device of claim 25, wherein each of the two drive devices (EM1, EM2) is connected to the respective gearwheel (10, 18) situated axially outward on one of the first and second transmission input shafts (7, 9).

27. The hybrid transmission device of claim 15, wherein both of the gearwheel (18) on the first transmission input shaft (7) and the gearwheel (10) on the second transmission input shaft (9) are gear-step fixed gear.

28. The hybrid transmission device of claim 15, wherein at least one of the gearwheels (10, 18), which is arranged axially outward and is arranged on an axis (A1) of the first transmission input shaft (7), is a fixed gear (10, 18).

29. A motor vehicle (1), comprising the hybrid transmission device of claim 15.
